(19) United States
(12) Patent Application Publication
(10) Pub. No.: US 2009/0223819 A1
(43) Pub. Date: Sep. 10, 2009

(54) CIRCUIT ARRANGEMENT FOR OPERATING A GUIDE PROBE

(75) Inventors: Goetz Reinhardt, Boeblingen (DE); Andreas Schaak, Ludwigsburg (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/305,334

(22) PCT Filed: Aug. 1, 2007
(86) PCT No.: PCT/EP07/57948

§ 371 Date: Dec. 17, 2008

(30) Foreign Application Priority Data
Sep. 1, 2006 (DE) 10 2006 041 184.6

(51) Int. Cl. G01N 27/26

(52) U.S. Cl. 204/424

(57) ABSTRACT

A circuit arrangement for operating a guide probe which is arranged behind a catalytic converter and has at least one reference electrode, which is arranged in a solid electrolyte, an exhaust gas electrode which is exposed to the exhaust gas and a porous ceramic coating which covers the exhaust gas electrode is characterized in that a resistor which influences the transport of oxygen ions between the reference electrode and the exhaust gas electrode in a targeted manner is arranged between the reference electrode and the exhaust gas electrode.

### TECHNICAL FIELD

The invention concerns a circuit arrangement for operating a guide probe that is arranged downstream of a catalytic converter with the features that are stated in the generic term of claim 1.

### BACKGROUND

An exhaust gas probe is known from DE 41 00 106 C1, at which the electrode that is exposed to the exhaust gas is covered by a porous ceramic protective layer, in which catalytically active materials are allocated discreetly and homogeneously in such a way, that the discreetly allocated catalytically active materials, preferably platinum, are active at higher temperatures, whereby the homogeneously allocated active components, preferably rhodium, are active at lower temperatures. Due to the lower amount of these substances especially an improvement of the sensor regulation position is achieved, especially at lower temperatures. The sensor has furthermore a simple manufacturing technology.

In such exhaust gas sensors with oxygen ion conducting solid electrolytes the transmission from a rich to a lean mixture is measured by measuring the potential between the exhaust gas probe and the reference electrode, which is exposed to a gas with defined oxygen content, as for example the ambient air. This transmission expresses itself in a strong jump of the probe voltage at the transmission from a rich to a lean mixture, which is often also called lambda jump. The exhaust gas probe is divided by a porous protective layer, which covers the exhaust gas probe.

The protective layer serves not only as mechanical protection of the exhaust gas electrode, but it also increases the so-called contamination resistance.

For controlling exhaust gas compositions downstream of a catalytic converter such jump probes are used as guide probes. Theses guide probes serve the controlling of the catalytic converter and are additionally used for balancing the probe that regulates the mixture formation upstream before the catalytic converter, the so-called pre-catalyst-probe. The regulation and the controlling of such a guide probe downstream of the catalytic converter is based on a control point, which is slightly moved away from the stoichiometric point (lambda=1) into the rich area. Thereby control voltages in the range of 600 mV to 700 mV are deployed.

A disadvantage at the adjustment of such a high control point is that even at a constant lambda the probe voltage depends on the proportion of the rich gas components carbon monoxide (CO) and hydrogen (H₂). Furthermore the gas composition at the control point also depends strongly on the probe temperature. That strong gas- and temperature dependency causes an increased effort for an optimal coordination of the control system. The catalytic converter can adjust the gas balances variably well after a rich/lean change over a longer period of time. Under certain circumstances there are working areas, in which no controlling onto a constant lambda value in the system is possible due to the different gas composition.

The invention is therefore based on the task to provide a circuit arrangement, which enables the increase of the accuracy of the rich gas measurement in a very small range with low rich gas concentrations. Furthermore the temperature dependency of the measuring signal shall be reduced.

### SUMMARY

The circuit arrangement for operating a guide probe that is arranged behind the catalytic converter according to the invention has the advantage that with the aid of a familiar jump probe rich gas components can be proven in the exhaust gas. Due to the resistor, which is arranged between the reference electrode and the exhaust gas electrode, and which purposefully influences an oxygen ion transport between the reference electrode and the exhaust gas electrode, a linear characteristic curve behavior at rich gas concentration is achieved in a very advantageous manner. It is also an extraordinary advantage that jump probes can be used as guide probes, which do not require additional circuit effort. The output signal is based on the familiar measurement of the probe voltage of such a jump probe.

The resistor is selected in such a way that the probe voltage that drops above it is lower than the Nernst voltage of the guide probe. Advantageous values of the resistor vary between 5000 and 20000 ohm.

Preferably the resistor and the porous coating are coordinated in such a way that the rich gas molecules that are accumulating in the porous coating are completely oxidized by oxygen ion transport that is caused by the resistor.

The porosity and the thickness of the porous coating are advantageously adjusted in such a way that an oxidation current flows in the range of 20 to 60 μA at an hydrogen content of 100 ppm. The values for the resistors and the oxidation current apply to the used electrode size. When changing the geometric area of the exhaust gas electrode the values have to be adjusted correspondingly.

By selecting applicable electrodes that are catalytically less active the sensitivity towards CO can be reduced. The output signal of the guide probe is then proportional to the hydrogen partial pressure.

### BRIEF DESCRIPTION OF THE DRAWINGS

Further advantages and features of the invention are subject matter of the following description as well as the drawing of embodiments. It is schematically shown in:

FIG. 1 is a structure of an exhaust gas probe;

FIG. 2a and 2b show circuit arrangements for operating a guide probe that are using the invention;

FIGS. 3a and 3b show a probe voltage as a function of the lambda value at typical post-catalyst gas compositions, wherein FIG. 3a is the probe voltage without wiring, and wherein FIG. 3b is the probe voltage with a wiring as it is shown in FIG. 2a; and

FIG. 4 shows the probe voltage over the concentration of hydrogen at two different resistors that are applied according to FIG. 2a between the reference electrode and the exhaust gas electrode.

### DETAILED DESCRIPTION

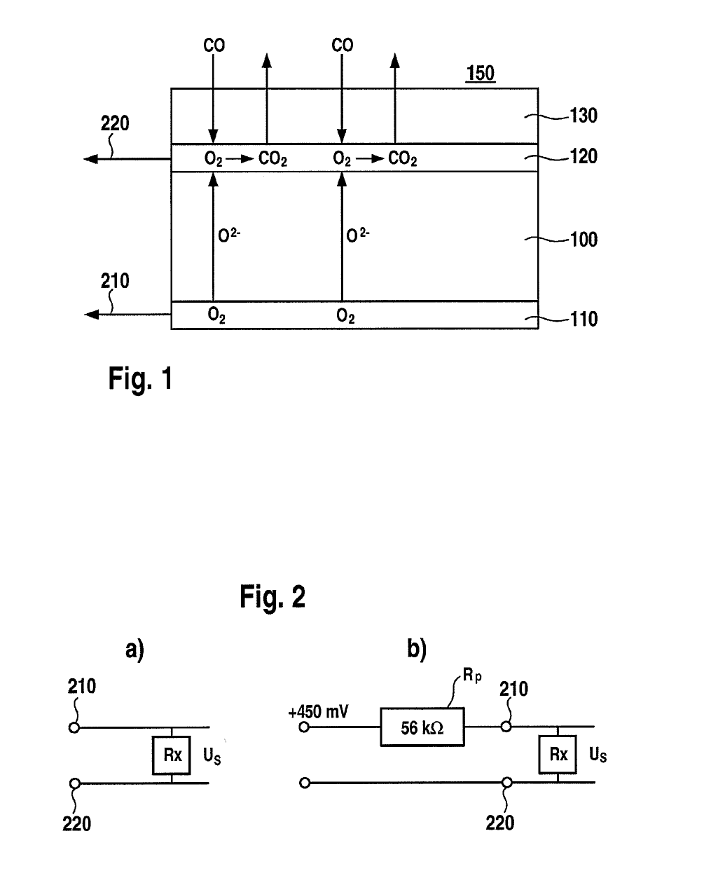

An exhaust gas probe, shown in FIG. 1, provides a solid electrolyte 100, in which a reference electrode 110 and an exhaust gas electrode 120 are arranged in a familiar way. The exhaust gas electrode 120 is exposed to an exhaust gas 150 and it is covered by a one- or multi-layered porous protective layer 130. The exhaust gas probe creates with the exhaust gas electrode 120 and the reference electrode 110 an independent voltage source.

The current of the oxygen ion (O²⁻-ions) from the reference electrode 110 to the exhaust gas electrode 120, as well as the current of carbon monoxide CO through the porous coating 130 to the exhaust gas electrode 120 are schematically shown in FIG. 1. The following reaction thereby takes place in the exhaust gas electrode 120:

CO+O²⁻→CO₂+2e⁻.

Furthermore another reaction of the rich gas hydrogen H₂ takes place in the exhaust gas electrode 120:

H₂+O²⁻→H₂O+2e⁻.

A circuit arrangement for operating a probe that is shown in FIG. 1 is schematically shown in FIG. 2. Thus the exhaust gas electrode 120 is connected with a clamp 220 and the reference electrode 110 with a clamp 210, in order to measure the probe voltage Uₛ. A resistor Rx (compare FIG. 2a) is applied between clamp 210 and clamp 220. Alternatively also a parallel resistor Rₚ can be provided between clamp 210 and the reference electrode 110, as it is schematically shown in FIG. 2b. This resistor amounts to e.g. 56 kΩ. A significant current of O²⁻-ions flows from the reference electrode 110 to the exhaust gas electrode 120 through the resistor Rx, which is applied parallel to the reference electrode 100 as well as to the exhaust gas electrode 120. This current that flows through the solid electrolyte 100, which builds the probe, is quasi picked up at the exhaust gas electrode 120 by the above state reactions with the rich gases H₂ and CO.

At a corresponding adjustment of the diffusion resistance of the protective layer 130 and at an optimized value of the parallel applied resistor Rx operating conditions can be set, at which basically each rich gas molecule that arrives in the protective layer 130 is oxidized. The current that flows through the arrangement is then proportional to the concentration to the component in the exhaust gas. Thereby the probe voltage Uₛ is also proportional to the concentration in the exhaust gas.

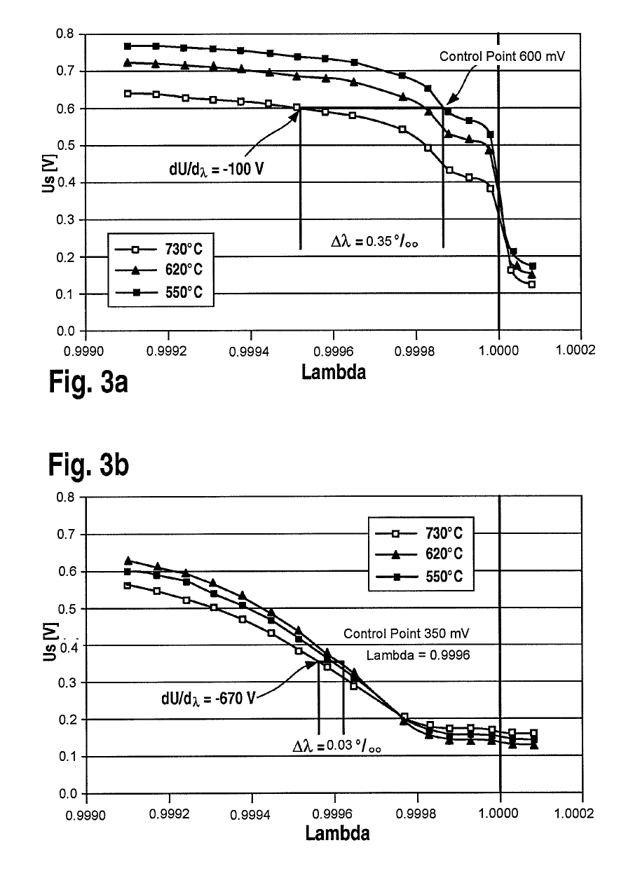

FIG. 3 shows the probe voltage Uₛ over the lambda value at such a probe. FIG. 3a shows thereby a not wired probe with the typical lambda jump at lambda=1 and at three different probe temperatures. At a usual control point of 600 mV the adjusted lambda value varies thereby by 0.35‰ in lambda. It is generally favorable for the controlling when the signal change over lambda at the control point is very high. At a not wired probe the increase dU/dλ at the control point −100 V is 730° C.

The same probe with a resistor Rx of 15 kΩ and the wiring from FIG. 2a for the same temperatures is shown in FIG. 3b. A linear course is found between the probe voltage and lambda in the range of probe voltages between 0.2 V and 0.45 V independent of the probe temperature. In that range the characteristic curve is almost independent of the probe temperature. At a control point of 350 mV a variation in lambda of 0.03‰ results. This is less by more than a dimension compared to the not wired probe. The increase at the control point dU/dλ with a value of −670 V is higher by a factor of ca. 6 as compared to the not wired probe. That significantly simplifies the controlling onto the control point. Advantageous values for the control point lie between λ=0.999 and λ=0.9998.

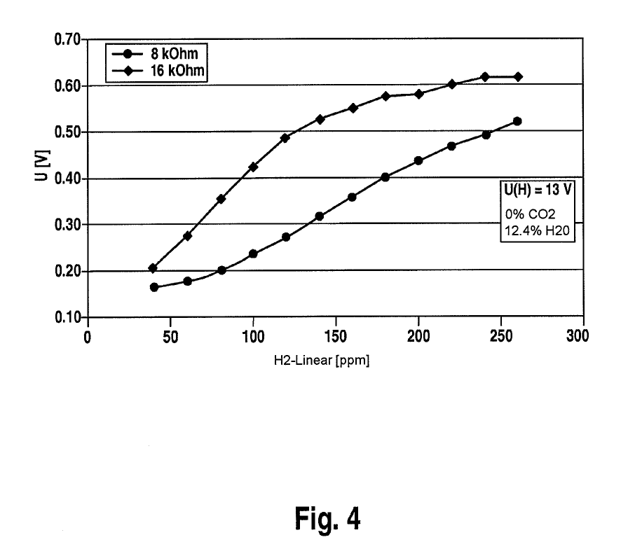

FIG. 4 shows the probe voltage as a function of the hydrogen content for resistors Rx of 8 kΩ and 16 kΩ. By the value of the resistor the linear area is adjusted at a set porosity of the coating. At 16 kΩ the characteristic curve runs between 40 ppm and 120 ppm, H₂ linear, at 8 kΩ between 80 ppm and 220 ppm.

It shall be pointed out that the pump capability of the reference air duct (not shown) has to be considered hereby. If sufficiently enough oxygen cannot be delivered in addition over the reference air, the previously stated reaction behavior is limited insofar.

In order to achieve a diffusion control, thus a targeted diffusion current, the resistor Rx is generally selected in such a way that the resulting probe voltage Uₛ is significantly lower than the corresponding Nernst voltage of the probe in dead state. This condition limits the upper voltage onto 0.45 V to 0.5 V. At probe voltages lower than 0.2 V oxygen is released as a further electrode reaction:

O²⁻→ 1/2 O₂+2e³¹ .

By the parallel reaction the current or the probe voltage Uₛ is increased.

When using the guide probe downstream after the catalytic converter hydrogen and carbon monoxide occur almost exclusively as rich gas components. Due to the faster diffusion of hydrogen it is proven with a significantly higher sensitivity. Familiar electrodes are partially catalytically more inactive regarding the electrode reaction with carbon monoxide. It is thereby possible with applicable selected catalytically inactive electrode materials to produce an increase of the selectiveness regarding H₂.

In order to avoid that the after-transport of oxygen over the reference air duct limits the pre-described measurements, as described above, protective layers 130 are used at this jump probe that is applied as a guide probe, which are thicker than protective layers at familiar jump probes. Alternatively or additionally a bigger reference air duct can also be provided. Hereby the pre-described linear area can be increased and optimized.

1-6. (canceled)

7. A circuit arrangement for measuring a component in an exhaust gas, comprising:
a guide probe arranged behind a catalytic converter, comprising:
at least one reference electrode;
an exhaust gas electrode, wherein a solid electrolyte is positioned between and separates the at least one reference electrode and the exhaust gas electrode, and wherein a porous ceramic coating covers the exhaust gas electrode; and
a resistor connected in parallel with the solid electrolyte, wherein a first resistor terminal is electrically connected to the at least one reference electrode and a second resistor terminal is electrically connected to the exhaust gas electrode;
wherein oxygen ion transport between the at least one reference electrode and the exhaust gas electrode develops a voltage across the resistor that is linearly dependent in a rich exhaust gas concentration having a lambda value less than 1, and wherein the voltage developed across the resistor at a lambda value near 1lacks influence of a Nernst voltage component.

8. The circuit arrangement of claim 7, wherein the resistor and the porous ceramic coating are configured to promote a complete oxidation of a plurality of molecules of the rich exhaust gas concentration that accumulate in the porous ceramic coating in a low lambda area having a lambda less than 1.

9. The circuit arrangement of claim 7, wherein the resistor has a resistance value between 5 kΩ and 20 kΩ.

10. The circuit arrangement of claim 7, wherein a porosity and a thickness of the porous ceramic coating are defined to promote an oxidation current between 20 μA and 60 μA to flow at a hydrogen concentration of 100 ppm H2.

11. The circuit arrangement of claim 10, wherein a resistor resistance value and the porosity and the thickness of the porous ceramic coating and are chosen to provide a probe voltage of 0.35 V to be developed in a lambda area between 0.999 and 0.9998.

12. The circuit arrangement of claim 7, wherein the resistor has a resistance value between 5 kΩ and 20 kΩ, and especially between 8 kΩ and 16 kΩ.
